(19) United States
(12) Patent Application Publication
(10) Pub. No.: US 2026/0196901 A1
(43) Pub. Date: Jul. 9, 2026

(54) HYBRID IMPREGNATION PROCESS FOR ELECTRIC VEHICLE MOTOR STATOR USING HOT MELT EPOXY-IMIDAZOLE CURE SYSTEM

(71) Applicants: Thanikaivelan Tindivanam Veeraraghavan, Newburgh, IN (US); Karthikeyan Sengotaiyan, Newburgh, IN (US); Senthilkumar Veeraraghavan, Newburgh, IN (US)

(72) Inventors: Thanikaivelan Tindivanam Veeraraghavan, Newburgh, IN (US); Karthikeyan Sengotaiyan, Newburgh, IN (US); Senthilkumar Veeraraghavan, Newburgh, IN (US)

(21) Appl. No.: 19/013,334

(22) Filed: Jan. 8, 2025

(51) Int. Cl. H02K 3/30; C08K 3/36; C09D 163/00; H02K 1/12; H02K 15/121

(52) U.S. Cl. CPC H02K 3/30; C09D 163/00; H02K 1/12; H02K 15/121; C08K 3/36

(57) ABSTRACT

A one-component epoxy varnish composition and hybrid impregnation process for insulating electric vehicle motor stators is provided. The composition comprises a bisphenol A epoxy resin, a multifunctional epoxy resin, a non-halogenated flame retardant, a cycloaliphatic anhydride hardener, an encapsulated imidazole catalyst, and a rheological additives. The composition exhibits high viscosity at room temperature for dip coating and low viscosity when heated for trickling application. A hybrid process enables coating both hairpin and crown wire regions using a single material system with simultaneous cure. The cured coating provides excellent electrical insulation, mechanical properties, and thermal resistance with glass transition temperature above 150° C., volume resistivity above 1.5×10\hat{ }14 Ω·cm, and UL94 V-0 flame rating.

### COPYRIGHT NOTICE

This application includes material that is subject to copyright protection. The copyright owner has no objection to the facsimile reproduction by anyone of the patent disclosure, as it appears in the United States Patent and Trademark Office files or records, but otherwise reserves all copyright rights whatsoever.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

### 1. Field of the Invention

The present invention relates generally to electrical insulation materials and processes for electric vehicle motor stators. More particularly, the invention relates to one-component hot melt epoxy varnish compositions and hybrid impregnation processes for insulating both hairpin and crown wire portions of electric vehicle motor stators using a single material system.

### 2. Background of the Invention

The rapid evolution of electric vehicle (EV) technology has created unprecedented demands on motor design and manufacturing. Modern electric vehicle motors must deliver increasing power density while maintaining reliability under demanding operating conditions. A critical aspect of motor performance and longevity is the electrical insulation system, particularly in the stator assembly. The stator, which contains both hairpin windings and crown wire regions, presents unique challenges for achieving consistent, high-performance insulation.

Conventional approaches to stator insulation have relied on separate materials and processes for different regions of the assembly. The hairpin portion, where individual conductors are joined through welding, typically requires a powder coating applied through a hot dip process at temperatures between 80-120° C. Meanwhile, the crown wire region traditionally receives a liquid epoxy varnish applied through trickling methods. This dual-material approach necessitates multiple application steps, separate curing cycles, and careful material selection to ensure compatibility between the different insulation systems.

The complexity of current methods creates several significant challenges. Manufacturing efficiency is compromised by the need to handle and process multiple materials. The requirement for separate curing cycles increases energy consumption and production time. Quality control becomes more demanding when monitoring two distinct insulation systems. Additionally, the interface between different insulation materials can create potential weak points in the overall system.

Some manufacturers have attempted to address these challenges using two-component room temperature curing systems. While these approaches eliminate the need for heated curing cycles, they introduce their own complications. Room temperature curing systems typically require several days to achieve full properties, dramatically increasing production time. They often exhibit limited storage stability once mixed and may not achieve the same level of thermal and mechanical properties as heat-cured systems.

The limitations of existing approaches have created a clear need for innovation in stator insulation technology. The ideal solution would utilize a single material system capable of effectively coating both hairpin and crown wire regions while providing superior electrical and mechanical properties. Such a system would need to exhibit suitable rheological behavior for different application methods while maintaining excellent storage stability. Most importantly, it would need to cure rapidly to a high-performance state without requiring multiple processing steps.

These and other objects of the present invention will become apparent in light of the present specification, claims, and drawings.

### SUMMARY OF THE INVENTION

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

The present invention addresses these challenges through an innovative one-component epoxy varnish system and hybrid impregnation process. This novel approach enables the insulation of both hairpin and crown wire regions using a single material system while achieving superior electrical and mechanical properties. The technology is based on careful utilization of resin chemistry, hardener selection, and rheological control to enable different application methods from a single formulation.

At the heart of the invention is a specialized epoxy varnish composition comprising multiple epoxy resins, a cycloaliphatic anhydride hardener, an encapsulated imidazole catalyst, and rheological modifiers. Each component has been carefully selected and proportioned to achieve specific performance targets, namely: (a) a base bisphenol A epoxy resin (approximately 20-30 weight percent) provides foundational properties and network formation; (b) a multifunctional epoxy resin (approximately 5-10 weight percent) enhances thermal performance and dimensional stability; (c) a non-halogenated phosphorus-containing flame retardant epoxy resin (approximately 5-10 weight percent) provides fire resistance without compromising electrical properties; (d) a cycloaliphatic anhydride hardener (approximately 35-65 weight percent) enables rapid cure and excellent high-temperature properties; (e) an encapsulated imidazole catalyst (approximately 0.1-5 weight percent) provides latency for storage stability while enabling rapid cure when heated; and (f) a fumed silica rheological additive (approximately 0-5 weight percent) controls flow behavior at different temperatures.

The composition exhibits carefully engineered rheological behavior that enables dual application methods. At room temperature, the material maintains high viscosity (>30 Pa·s) for excellent coating uniformity. When heated to moderate temperatures (40-80° C.), the viscosity reduces dramatically (to ~4 Pa·s) to enable both dip coating and trickling applications. This unique behavior allows the material to be applied effectively to both the hairpin and crown wire regions of the stator.

The invention also encompasses a novel hybrid impregnation process that takes advantage of these material properties. The process comprises the steps of: (1) heating the composition to 40-80° C. for reduced viscosity; (2) dip coating the hairpin region of the stator; (3) allowing the coating to cool and set at room temperature; (4) repositioning the stator assembly; (5) heating the composition to 60-80° C.; (6) applying the heated composition to the crown wire region via trickling; and (7) curing both regions simultaneously at 150° C. for one hour.

This novel process provides several significant advantages over conventional methods, namely: the single material system simplifies handling and inventory; the one-step cure reduces energy consumption and processing time; establishes uniform properties across all insulated regions; affords excellent adhesion and void-free coating and provides for superior thermal and mechanical properties.

The cured coating exhibits an exceptional combination of properties that exceed conventional systems, including, but not limited to:

### Electrical Properties:

Volume resistivity >1.5×10\hat{ }14 Ω·cm
Dielectric constant: 2.45-4.2
Dissipation factor: 0.003-0.005 at 1 KHz
Breakdown voltage >15 kV/mm

### Mechanical Properties:

Tensile strength >40 MPa
Tensile modulus >2.0 GPa
Elongation >1.5%
Flexural strength >60 MPa
Flexural modulus >2.0 GPa
Lap shear strength 10.0 Mpa at ambient temperature and pressure
Viscosity at 25° C. (Pa·s)>30 Pa·s
Viscosity at 80° C. (Pa·s)<4.0 Pa·s

### Thermal Properties:

Glass transition temperature >150° C.
Thermal conductivity: 0.2-2.0 W/m-K
UL94 V-0 flame rating

### BRIEF DESCRIPTION OF THE DRAWINGS

Certain embodiments of the present invention are illustrated by the accompanying figures. It will be understood that certain figures are not necessarily to scale and that details not necessary for an understanding of the invention or that render other details difficult to perceive may be omitted.

It will be further understood that the invention is not necessarily limited to the particular embodiments illustrated herein.

The invention will now be described with reference to the drawings wherein:

FIG. 1 is a cross-sectional view of an electric vehicle motor stator showing the hairpin side and crown wire regions according to an embodiment of the present invention; and

FIG. 2 is a table (Table 2) showing test properties for Experiment 1 through Experiment 5.

### DETAILED DESCRIPTION OF THE INVENTION

While this invention is susceptible of embodiment in many different forms and applications, there are shown in the drawings and described herein in detail several specific embodiments with the understanding that the present disclosure is to be considered as an exemplification of the principles of the invention and is not intended to limit the invention to the embodiments illustrated.

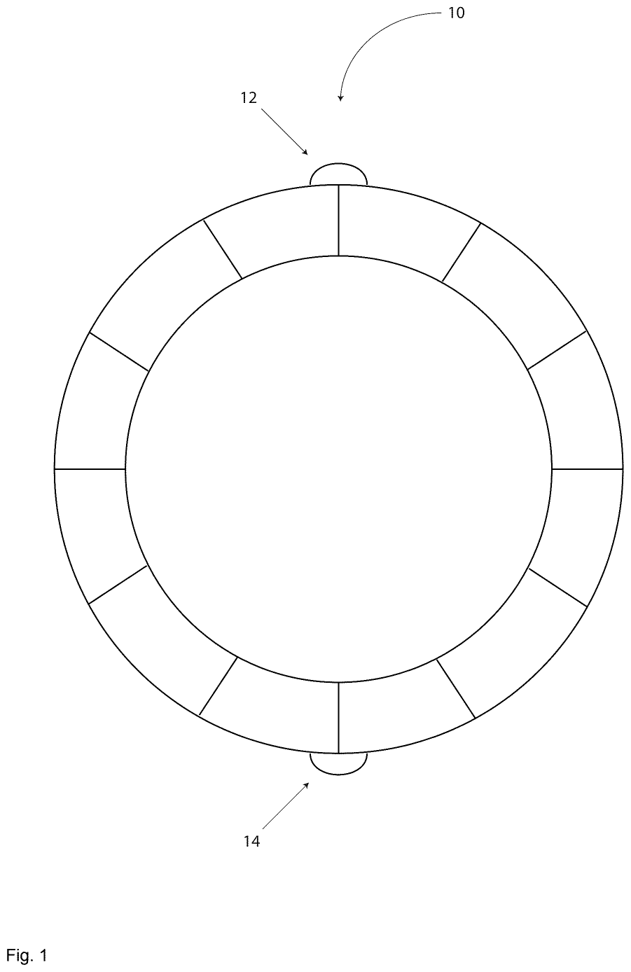

Referring now to the drawings, and to FIG. 1 in particular, the present invention is directed to an insulated electric vehicle motor stator 10, comprising: a stator core having a hairpin portion 12 and a crown wire portion 14, and an insulating coating formed from a cured one-component epoxy varnish composition. The composition generally includes: (a) at least one bisphenol A based epoxy resin, (b) at least one multifunctional epoxy resin, (c) a non-halogenated phosphorus-containing flame retardant epoxy resin, (d) a cycloaliphatic anhydride hardener, (e) an encapsulated imidazole catalyst, and (f) an optional fumed silica rheological additive.

### Epoxy Resin System

The epoxy resin system forms the foundation of the composition through a carefully optimized blend of components. The primary component is a bisphenol A based epoxy resin, specifically a diglycidyl ether of bisphenol A (DGEBA), which provides the basic network structure for the cured system and comprises the following chemical structure:

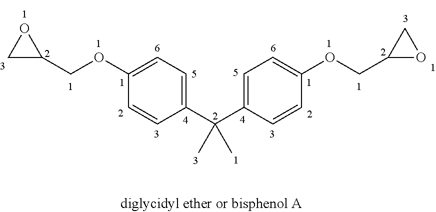 [SMILES: CC(C)(c1ccc(OCC2CO2)cc1)c1ccc(OCC2CO2)cc1]

This resin is selected for its combination of properties including good adhesion to metal substrates, excellent electrical insulation characteristics, and balanced mechanical properties after cure.

The DGEBA resin comprises 20-30 weight percent of the total composition and typically has an epoxy equivalent weight between 185-190 g/eq. This molecular weight range has been found optimal for achieving the desired balance of uncured viscosity and cured properties. Commercial examples include YD128 from Kukdo Chemical Company, which provides excellent batch-to-batch consistency and reliable performance.

Additional examples of bisphenol A based epoxy resins, include, but are not limited to, 2,2-bis(4-glycidyloxyphenyl)propane—BPA diglycidyl ether (BADGE/DGEBA), 2,2-bis(3-methyl-4-glycidyloxyphenyl)propane—Methylated variant with improved thermal properties, 2,2-bis(3-chloro-4-glycidyloxyphenyl)propane—Halogenated derivative with enhanced flame retardancy, 2,2-bis(4-glycidyloxy-3,5-dibromophenyl)propane—Tetrabrominated version for fire resistance, 2,2-bis(4-glycidyloxy-3,5-dimethylphenyl)propane—Tetramethylated analog with lower viscosity, 2,2-bis(4-glycidyloxy-3-ethylphenyl)propane—Diethylated variant with improved processability, 2,2-bis(4-glycidyloxy-3-tert-butylphenyl)propane—Bulky substituent version for higher glass transition, 2,2-bis(4-glycidyloxy-3-fluorophenyl)propane—Fluorinated derivative with chemical resistance, 2,2-bis(4-glycidyloxy-3-isopropylphenyl)propane—Branched alkyl variant with enhanced solubility, and 2,2-bis(4-glycidyloxy-3-methoxy-5-methylphenyl)propane—Mixed substituent version with unique properties. These variations maintain the core BPA structure while introducing different functional groups to modify properties like thermal stability, flame resistance, processability, and chemical resistance.

A key feature of the invention is the incorporation of 5-10 weight percent of a multifunctional epoxy resin, which may be either dicyclopentadiene-based or naphthalene-type. These specialized resins serve multiple functions in the system, namely: (a) dicyclopentadiene-based resins provide excellent dimensional stability through reduced shrinkage during cure; (b) naphthalene-type resins contribute to enhanced heat resistance through their rigid molecular structure; (c) both types increase crosslink density in the cured network, improving mechanical properties; and (d) the additional functionality helps maintain properties at elevated temperatures.

The combination of DGEBA with these multifunctional resins creates a network structure that maintains its properties at elevated temperatures while providing the toughness needed to resist mechanical stresses during motor operation. A particularly effective example is Epiclon 9540 from Sun Chemical Corporation, which contributes to achieving glass transition temperatures above 180° C. in the cured system.

Other examples of multifunctional epoxy resins (dicyclopentadiene-based) include, but are not limited to: 5,5′-[(dicyclopentadiene-2,3:5,6-diyl)bis(methylene)]bis(oxirane) DCPD diglycidyl ether, 5,5′,5″-[(dicyclopentadiene-2,3:5,6:8,9-triyl)tris(methylene)]tris(oxirane)-Triglycidyl DCPD derivative, 2,3,5,6-tetrakis(glycidyloxymethyl)dicyclopentadiene Tetraglycidyl functionalized DCPD, 2,3,5,6,8,9-hexakis (glycidyloxymethyl)dicyclopentadiene-Hexaglycidyl DCPD variant, 5,5′-[(3-methyldicyclopentadiene-2,3:5,6-diyl)bis(methylene)]bis(oxirane)-Methylated DCPD diglycidyl ether, 5,5′-[(3-phenyldicyclopentadiene-2,3:5,6-diyl)bis(methylene)]bis(oxirane)-Phenyl-substituted DCPD diglycidyl, 2,3,5,6-tetrakis(2,3-epoxypropyl)dicyclopentadiene-Direct C-glycidyl DCPD derivative, 5,5′-[(3,4-dimethyldicyclopentadiene-2,3:5,6-diyl)bis(methylene)]bis(oxirane)-Dimethylated variant, 5,5′-[(3-chlorodicyclopentadiene-2,3:5,6-diyl)bis(methylene)]bis(oxirane)-Halogenated DCPD diglycidyl, and 2,3,5,6-tetrakis(3-methylglycidyloxymethyl)dicyclopentadiene-Methylated glycidyl DCPD variant. These structures offer varying degrees of functionality and substitution patterns to modulate properties like crosslink density, thermal stability, and mechanical performance.

Other examples of multifunctional epoxy resins (naphthalene-based) include, but are not limited to: 2,6-bis(glycidyloxy) naphthalene-diglycidyl naphthalene ether (DGNE), 2,7-bis(glycidyloxy) naphthalene-Positional isomer of diglycidyl naphthalene ether, 1,5-bis(glycidyloxy)naphthalene—Alternative diglycidyl naphthalene isomer, 1,4,5,8-tetrakis(glycidyloxy) naphthalene—Tetraglycidyl naphthalene derivative, 2,6-bis(glycidyloxy)-1,5-bis(glycidylmethyl)naphthalene—Mixed glycidyl ether/glycidylmethyl functionality, 2,3,6,7-tetrakis(glycidyloxy) naphthalene—Symmetrical tetraglycidyl naphthalene, 1,4,6,7-tetrakis(glycidyloxy)-2-methylnaphthalene—Methylated tetraglycidyl variant, 2,6-bis(glycidyloxy)-1,5-bis(3-methylglycidyloxy)naphthalene—Methylated mixed functionality, 1,3,6,8-tetrakis(glycidyloxy)naphthalene—Alternative tetrasubstituted pattern, and 2,7-bis(glycidyloxy)-1,6-bis(2,3-epoxypropyl) naphthalene—Combined ether/direct glycidyl functionality. These structures utilize the rigid naphthalene core with various glycidyl substitution patterns to achieve high thermal stability, mechanical strength, and controlled crosslinking density in the cured resins.

The third important component is a non-halogenated phosphorus-containing flame retardant epoxy resin, incorporated at 5-10 weight percent. This specialized resin serves multiple functions, namely: (a) provides flame resistance without traditional halogenated compounds; (b) maintains high electrical insulation properties; (c) becomes permanently incorporated into the polymer network; (d) prevents migration or blooming issues; and contributes to achieving UL94 V-0 rating.

Examples of non-halogenated phosphorus-containing flame retardant epoxy resins include, but are not limited to: 9,10-dihydro-9-oxa-10-phosphaphenanthrene-10-oxide (DOPO) modified diglycidyl ether of bisphenol A —phosphaphenanthrene oxide epoxy, Bis(4-glycidyloxyphenyl)phenylphosphine oxide—Phosphine oxide-based diglycidyl ether, Tris(4-glycidyloxyphenyl)phosphate—Phosphate-based triglycidyl derivative, 2,5-bis(glycidyloxy)phenylphosphonic acid—Phosphonic acid containing diglycidyl compound, 4,4′-bis(glycidyloxy)phenyl phosphinate—Phosphinate-linked diglycidyl structure, Tris(4-glycidyloxyphenyl)phosphine oxide—Phosphine oxide with three glycidyl groups, 2-(diphenylphosphino)phenyl glycidyl ether—Monoglycidyl phosphine derivative, Bis(4-glycidyloxy-3,5-dimethylphenyl)phosphonate—Dimethylated phosphonate diglycidyl, 4,4′-bis(glycidyloxy) biphenyl phosphonate—Biphenyl-based phosphonate diglycidyl, and Tris(2-glycidyloxyethyl)phosphate—Flexible spacer phosphate triglycidyl. These structures incorporate various phosphorus-containing groups (phosphine oxides, phosphates, phosphonates, etc.) to provide flame retardancy while maintaining epoxy functionality for crosslinking.

### Hardener System

The selection and optimization of the hardener system is crucial for achieving the desired combination of processing characteristics and final properties. The composition employs a cycloaliphatic anhydride hardener system comprising 35-65 weight percent of the total formulation. Through extensive experimentation, methyl nadic anhydride (methyl-5-norbornene-2,3-dicarboxylic anhydride) has been identified as particularly effective for this application. Methyl nadic anhydride provides several crucial advantages:

### Processing Benefits:

Low viscosity at elevated temperatures
High boiling point (140° C. at 70 mm Hg)
Low vapor pressure (5 mm Hg at 120° C.)
Excellent wetting of metal substrates
Controlled exotherm during cure

### Property Contributions:

High glass transition temperature
Excellent mechanical strength
Good electrical properties
Low shrinkage during cure
Enhanced adhesion to substrates

The rigid bicyclic structure of methyl nadic anhydride contributes to high glass transition temperature and excellent mechanical properties in the cured resin. Meanwhile, its relatively low molecular weight and cycloaliphatic nature provide low viscosity during processing. The combination of high boiling point and low vapor pressure is critical for preventing volatilization during the degassing and cure processes.

While methyl nadic anhydride is preferred, other cycloaliphatic anhydride hardeners may be used alone or in combination to achieve specific property modifications, including: methylhexahydrophthalic anhydride which offers enhanced flow at lower temperatures, tetrahydrophthalic anhydride which provides cost advantages in some formulations, and hexahydrophthalic anhydride can improve flexibility in the cured system.

Indeed, the curable composition may comprise one or more anhydride-based curing agents selected from aromatic, aliphatic, cycloaliphatic, and heterocyclic polycarboxylic acid anhydrides. Particularly suitable curing agents include, but are not limited to, phthalic anhydride, tetrahydrophthalic anhydride, methyl tetrahydrophthalic anhydride, hexahydrophthalic anhydride, methyl hexahydrophthalic anhydride, nadic methyl anhydride, succinic anhydride, dodecenylsuccinic anhydride, glutaric anhydride, pyromellitic anhydride, maleic anhydride, isatoic anhydride, benzophenonetetracarboxylic anhydride, and combinations thereof.

In certain embodiments, the curing agent comprises liquid cyclic anhydrides, preferably selected from tetrahydrophthalic anhydride, methyl tetrahydrophthalic anhydride, hexahydrophthalic anhydride, methyl hexahydrophthalic anhydride, and nadic methyl anhydride. Among these, nadic methyl anhydride is particularly advantageous due to its desirable properties including room temperature liquidity, low viscosity (less than about 300 mPa·s at 25° C.), high boiling point (approximately 132° C. at 2 mm Hg), and low volatilization during degassing. Additionally, nadic methyl anhydride demonstrates excellent filler wettability, promotes adhesion to cured epoxy resins, exhibits low exothermic behavior during cure, and contributes to enhanced glass transition temperature (Tg) in the cured product.

The anhydride curing agent may be present in the composition in an amount ranging from about 7 wt % to about 50 wt % of the total composition. In specific embodiments, the curing agent may comprise a combination of nadic methyl anhydride and methyl tetrahydrophthalic anhydride, wherein the nadic methyl anhydride constitutes about 5 wt % to about 95 wt % of the total liquid cyclic anhydride content. Particularly preferred ranges for nadic methyl anhydride in such combinations are from about 35 wt % to about 65 wt % of the total liquid cyclic anhydride content, which has been found to provide optimal curing characteristics and final product properties.

### Catalyst System

The catalyst system is a critical enabler of the single-component technology. The invention utilizes encapsulated imidazole catalysts at 0.1-5 weight percent, which provide an optimal balance of storage stability and cure response. The encapsulation technology prevents premature reaction between the epoxy resins and anhydride hardener while allowing rapid cure when heated to the designated temperature.

Several types of encapsulated imidazole catalysts have proven effective, including: microencapsulated 2-methylimidazole (Novacure HX series from Asahi Kasei), microencapsulated 2-phenyl-4-methylimidazole (Resicure LC series from ACCI Specialty Materials), and microencapsulated 2-ethyl-4-methylimidazole (Ajicure grades from Ajinomoto).

The encapsulation technology is carefully engineered to maintain stability below 100° C. while releasing active catalyst rapidly at cure temperature. This enables: (a) storage stability >90 days at room temperature, (b) gel times of 100-150 seconds at 150° C., (c) complete cure in 1 hour at 150° C., and (d) excellent batch-to-batch consistency.

Indeed, the curable composition may comprise one or more catalysts selected from imidazoles, imidazolium salts, tertiary amines, reaction products of halogen bisphenol and tertiary amines, adducts of imidazole and sulfur dioxide, BF3-complexes, urea accelerators, alcohols, carboxylic acids, quaternary ammonium salts, organometallic salts, and combinations thereof. In particularly preferred embodiments, the catalyst system comprises imidazole compounds, which may be selected from 2-methylimidazole, 2-undecylimidazole, 2-heptadecylimidazole, 1,2-dimethylimidazole, 2-ethyl-4-methylimidazole, 2-phenylimidazole, 2-phenyl-4-methylimidazole, 1-benzyl-2-methylimidazole, and 1-benzyl-2-phenylimidazole.

The catalyst system may additionally or alternatively comprise functionalized imidazole derivatives, including cyano-containing derivatives such as 1-cyanoethyl-2-methylimidazole, 1-cyanoethyl-2-undecylimidazole, and 1-cyanoethyl-2-phenylimidazole; azine-containing derivatives such as 2,4-diamino-6-[2′methylimidazolyl-(1′)]-ethyl-s-triazine and 2,4-diamino-6-[2′-undecylimidazolyl-(1′)]-ethyl-s-triazine; and hydroxyl-containing derivatives such as 2-phenyl-4,5-dihydroxymethylimidazole and 2-phenyl-4-methyl-5-hydromethylimidazole adduct. For enhanced storage stability and controlled reactivity, microencapsulated forms of the imidazole or amine catalysts may be employed.

The catalyst may be present in an amount ranging from about 0.001 parts to about 5 parts by weight, based on 100 parts by weight of the epoxy resin. More preferably, the catalyst content ranges from about 0.005 parts to about 3 parts by weight, and most preferably from about 0.10 parts to about 2.0 parts by weight, based on 100 parts by weight of the epoxy resin. When tertiary amine catalysts are employed, they may be selected from benzyldimethyl amine, 2,2-(dimethylamine methyl) phenol, 2,4,6-tris(dimethylamine methyl) phenol, triethanolamine, triethylamine, triethylenediamine, and combinations thereof. The microencapsulated form of these catalysts provides particularly advantageous storage stability while maintaining rapid cure characteristics when activated at appropriate temperatures.

### Rheological Control System

The ability to apply the material through different methods is enabled by careful control of rheological behavior. The composition includes 0-5 weight percent of surface-treated fumed silica as a rheological additive. This creates thixotropic behavior-high viscosity at rest for coating uniformity, but flowable under shear or heating.

The rheological system provides: (a) room temperature viscosity >30 Pas for coating stability, (b) heated viscosity <4 Pa·s for application, (c) excellent sag resistance on vertical surfaces, (d) good leveling for smooth coating, and (e) prevention of filler settling during storage.

### Preparation Method

The preparation method has been optimized to ensure consistent product quality and performance. The process comprises the following steps:

### 1. Initial Resin Mixing:

Combine epoxy resins at 30-60° C.
Mix for 30 minutes under nitrogen
Cool below 25° C.

### 2. Hardener Addition:

Add anhydride hardener with mixing
Maintain temperature below 25° C.
Mix for 15-20 minutes

### 3. Rheological Additive:

Add fumed silica gradually
Mix for 20 minutes at 25° C.
Ensure complete dispersion

### 4. Catalyst Addition:

Add encapsulated catalyst
Mix under vacuum for 45 minutes
Control temperature below 30° C.

### 5. Final Processing:

Filter through 100-micron mesh
Package under nitrogen
Store below 25° C.

### Application Process

The hybrid impregnation process takes advantage of the material's novel and unique rheological properties to effectively coat both the hairpin and crown wire regions of the stator. The process includes several carefully controlled steps:

### For Hairpin Side Coating:

1. Heat composition to 40-80° C. to reduce viscosity
2. Verify viscosity is within 30-50 Pa·s range
3. Dip coat hairpin region at controlled speed
4. Hold for 2-3 minutes to ensure complete wetting
5. Withdraw at controlled rate
6. Allow to cool and set at room temperature

### For Crown Wire Coating:

1. Heat composition to 60-80° C.
2. Verify viscosity is within 4-12 Pa·s range
3. Apply via heated header at controlled flow rate
4. Maintain material temperature through insulated delivery system
5. Control application pattern for complete coverage
6. Allow material to flow and wet surfaces

### Curing Process

1. Place coated stator in forced air oven
2. Heat to 100° C. for 1 hour
3. Increase to 150° C. for 1 hour
4. Final post-cure at 180° C. for 3 hours
5. Cool gradually to room temperature

### Properties and Performance

The composition and process provide an exceptional combination of properties that exceed conventional systems:

### Electrical Properties:

Volume resistivity: >1.5×10\hat{ }14 Ω·cm
Dielectric constant: 2.45-4.2 (1 kHz)
Dissipation factor: 0.003-0.005 (1 kHz)
Breakdown voltage: >15 kV/mm

### Mechanical Properties:

Tensile strength: >40 MPa
Tensile modulus: >2.5 GPa
Elongation: >1.5%
Flexural strength: >60 MPa
Flexural modulus: >2.0 GPa
Hardness: >70 Shore D

### Thermal Properties:

Glass transition temperature: >150° C.
Thermal conductivity: 0.2-2.0 W/m-K
UL94 V-0 flame rating
Thermal index: >180° C.

### Adhesion Performance:

Lap shear strength (MPa):
−25° C.: >12.0
150° C.: >10.0
180° C.: >8.0
200° C.: >8.0
230° C.: >2.0

### Environmental Properties:

Moisture absorption: <0.6% (24 h/50° ° C.)
Chemical resistance: Excellent to oils and coolants
Weather resistance: No significant degradation after 1000 h
Thermal cycling: Maintains properties through 100 cycles

### Experiments

### Base Blend—A1

Experimental are prepared by mixing epoxy resins, curing agents and other additives, as indicated in Table 1, at ambient temperatures YD128 epoxy (a bisphenol-A based epoxy resin (reaction product of epichlorohydrin and bisphenol-A) resin having about 35 weight percent available from Kukdo chemical Company, Korea, Add 10 weight percent of Epoiclon 9540 Epoxy resin (naphthalane tpe epoxy) available from Sun chemical corporation, USA, then mix the composition at 30-60 C for 30 minutes, after mixing bring the composition to room temperature or below 25 C then add METH E anhydride curing agent (Nadic methyl anhydride) having 45.5 weight percent, available from Polynt Intermediates & Specialties, Cavaglià, then add 2 weight percent Fumed silica (DMS treated rheological additive) available from CABOT USA mix the composition for 20 minutes at 25 C temperature. The degassed mixtures is Base blend.

### Experiment 1

For the initial mixing stage, charge 427.5 g of base blend 1 into the mixing vessel. Mix under nitrogen atmosphere for 10 minutes at 15 RPM, then continue mixing without nitrogen for 20 minutes at 30 RPM. Scrape the mixing blades and container walls. Subsequently, add 22.5 g of catalyst (1) and mix under nitrogen atmosphere for 10 minutes at 45 RPM, followed by mixing without nitrogen for 45 minutes at 45 RPM under vacuum. Check the viscosity before discharging the mixture. The curing profile demonstrates good green strength (gel time) between 2-3 minutes at 150° C. Complete cure is achieved through a sequential heating schedule of 1 hour at 100° C., followed by 1 hour at 150° C., and finally 3 hours at 180° C.

### Experiment 2

Begin by charging 441 g of base blend 1 into the mixing vessel. Mix under nitrogen atmosphere for 10 minutes at 15 RPM, then continue mixing without nitrogen for 20 minutes at 30 RPM. Scrape the mixing blades and container walls. Add 9 g of catalyst (2) and mix under nitrogen atmosphere for 10 minutes at 45 RPM, followed by mixing without nitrogen for 45 minutes at 45 RPM under vacuum. Check the viscosity before discharging the mixture. The curing profile shows good green strength (gel time) between 2-3 minutes at 150° C. Complete cure is achieved through a sequential heating schedule of 1 hour at 100° C., followed by 1 hour at 150° C., and finally 3 hours at 180° C.

### Experiment 3

Start by charging 441 g of base blend 1 into the mixing vessel. Mix under nitrogen atmosphere for 10 minutes at 15 RPM, then continue mixing without nitrogen for 20 minutes at 30 RPM. Scrape the mixing blades and container walls. Add 9 g of catalyst (3) and mix under nitrogen atmosphere for 10 minutes at 45 RPM, followed by mixing without nitrogen for 45 minutes at 45 RPM under vacuum. Check the viscosity before discharging the mixture. The curing profile exhibits good green strength (gel time) between 2-3 minutes at 150° C. Complete cure is achieved through a sequential heating schedule of 1 hour at 100° C., followed by 1 hour at 150° C., and finally 3 hours at 180° C.

### Experiment 4

Begin with charging 441 g of base blend 1 into the mixing vessel. Mix under nitrogen atmosphere for 10 minutes at 15 RPM, then continue mixing without nitrogen for 20 minutes at 30 RPM. Scrape the mixing blades and container walls. Add 9 g of catalyst (4) and mix under nitrogen atmosphere for 10 minutes at 45 RPM, followed by mixing without nitrogen for 45 minutes at 45 RPM under vacuum. Check the viscosity before discharging the mixture. The curing profile demonstrates good green strength (gel time) between 2-3 minutes at 150° C. Complete cure is achieved through a sequential heating schedule of 1 hour at 100° C., followed by 1 hour at 150° C., and finally 3 hours at 180° C.

### Experiment 5:

Start by charging 441 g of base blend 1 into the mixing vessel. Mix under nitrogen atmosphere for 10 minutes at 15 RPM, then continue mixing without nitrogen for 20 minutes at 30 RPM. Scrape the mixing blades and container walls. Add 9 g of catalyst (5) and mix under nitrogen atmosphere for 10 minutes at 45 RPM, followed by mixing without nitrogen for 45 minutes at 45 RPM under vacuum. Check the viscosity before discharging the mixture. The curing profile shows good green strength (gel time) between 2-3 minutes at 150° C. Complete cure is achieved through a sequential heating schedule of 1 hour at 100° C., followed by 1 hour at 150° C., and finally 3 hours at 180° C.

TABLE 1
(Catalyst)

Composition

| | | | | |
|---|---|---|---|---|
| Exp 1 | Exp 2 | Exp 3 | Exp 4 | Exp 5 |

Base blend

| S. no | | 427.5 | 441 | 441 | 441 | 441 |
|---|---|---|---|---|---|---|
| 2 | Catalyst 1 | 22.50 | 0 | 0 | 0 | 0 |
| 3 | Catalyst 2 | 0 | 9 | 0 | 0 | 0 |
| 4 | Catalyst 3 | 0 | 0 | 9 | 0 | 0 |
| 5 | Catalyst 4 | 0 | 0 | 0 | 9 | 0 |
| 6 | Catalyst 5 | 0 | 0 | 0 | 0 | 9 |

Catalyst 1—Novacure Hx 3072
Catalyst 2—Resicure Lc 80
Catalyst 3—Resicure Lc 100
Catalyst 4—Ajicure My25
Catalyst 5—Ajicure Pn 50

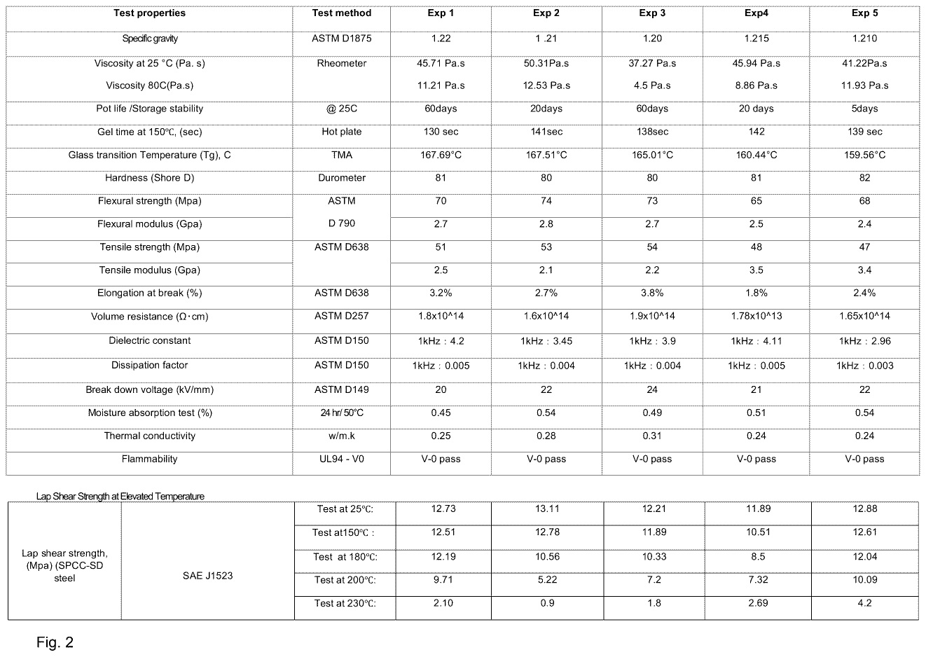

### See FIG. 2 for Table 2 (Test Results).

TABLE 3
Conventional Powder Coating Test Properties

| Color | Light Green | |
|---|---|---|
| Specific gravity | 1.6 | |
| Shelf life | 180 | days |
| Moisture absorption test | 0.6% | |
| Breakdown voltage | 20,000 | v |
| Volume resistivity | 1.0 × 10\hat{ }13 | ohms · cm |
| Dielectric constant @23 C./1 kHz | 3.5 | |
| Edge coverage | >45% | |
| Impact strength | 500 | mm |
| Flexural strength | >105 | Mpa |
| Flexutral modulus | >30 | Mpa |
| Thermal conductivity | >0.7 | w/m · k |
| CTE | 50 | pp/C. |
| Gel time @ 150 C. | 20-60 | Sec |
| Insulation class | F (155° C.) | |
| Glass tarnstiin temperature(Tg) | 110° | C. |
| Melting temperature | 98-110° | C. |

TABLE 4
(Viscosity vs. Temperature)

| | Exp -1 | Exp -2 | Exp -3 | Exp -4 | Exp -5 |
|---|---|---|---|---|---|
| Temperature | Viscosity | Viscosity | Viscosity | Viscosity | Viscosity |
| (° C.) | (Pa · s) | (Pa · s | (Pa · s | (Pa · s | (Pa · s |
| 25.288 | 45.7119 | 50.5193 | 37.2784 | 45.9427 | 41.2338 |
| 30.739 | 36.8796 | 41.0313 | 28.9028 | 37.1741 | 36.0678 |
| 40.803 | 25.236 | 29.2689 | 18.6865 | 25.1896 | 27.3171 |
| 50.791 | 18.0733 | 20.846 | 12.2521 | 18.0102 | 20.4919 |
| 60.76 | 14.9754 | 17.3187 | 8.22465 | 13.7307 | 15.72 |
| 70.761 | 13.6679 | 15.6701 | 5.8199 | 10.7278 | 12.5513 |
| 79.965 | 11.2109 | 12.5317 | 4.5038 | 8.86481 | 11.935 |

The foregoing description merely explains and illustrates the invention and the invention is not limited thereto except insofar as the appended claims are so limited, as those skilled in the art who have the disclosure before them will be able to make modifications without departing from the scope of the invention.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etcetera shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etcetera. As a non-limiting example, each range discussed herein can be readily broken down into a lower third, middle third and upper third, etcetera. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed and desired to be secured by Letters Patent of the United States is:

1. A one-component epoxy varnish composition, comprising:
(a) 20-30 weight percent of at least one bisphenol A based epoxy resin;
(b) 5-10 weight percent of at least one multifunctional epoxy resin selected from dicyclopentadiene-based epoxy resins and naphthalene-type epoxy resins;
(c) 5-10 weight percent of a non-halogenated phosphorus-containing flame retardant epoxy resin;
(d) 35-65 weight percent of a cycloaliphatic anhydride hardener;
(e) 0.1-5 weight percent of an encapsulated imidazole catalyst; and
(f) 0-5 weight percent of a fumed silica rheological additive.

2. The composition according to claim 1, wherein the composition has a viscosity greater than 30 Pa·s at 25° C. and less than 4 Pa·s at 80° C.

3. The composition according to claim 1, wherein the cycloaliphatic anhydride hardener comprises methyl nadic anhydride.

4. The composition according to claim 1, wherein the encapsulated imidazole catalyst is selected from microencapsulated 2-methylimidazole, microencapsulated 2-phenyl-4-methylimidazole, and microencapsulated 2-ethyl-4-methylimidazole.

5. The composition according to claim 1, having a storage stability of at least 90 days at room temperature without substantial change in viscosity or gel time.

6. The composition according to claim 1, having a gel time of 100-150 seconds at 150° C.

7. The composition according to claim 1, wherein upon curing at 150° C. for 1 hour provides a cured product having a glass transition temperature above 150° C.

8. The composition according to claim 1, wherein upon curing at 150° C. for 1 hour provides a cured product having:
(a) a tensile strength above 40 MPa;
(b) a tensile modulus above 2.0 GPa;
(c) an elongation greater than 1.5%;
(d) a flexural strength above 60 MPa; and
(e) a flexural modulus above 2.0 GPa.

9. The composition according to claim 1, wherein upon curing at 150° C. for 1 hour provides a cured product having:
(a) a volume resistivity above 1.5×10\hat{ }14 Ω·cm;
(b) a dielectric constant between 2.5-4.2;
(c) a dissipation factor between 0.003-0.005 at 1 KHz; and
(d) a breakdown voltage above 15 kV/mm.

10. A process for insulating an electric vehicle motor stator, comprising the steps of:
(a) providing a one-component epoxy varnish composition comprising: (i) 20-30 weight percent of at least one bisphenol A based epoxy resin; (ii) 5-10 weight percent of at least one multifunctional epoxy resin; (iii) 5-10 weight percent of a non-halogenated phosphorus-containing flame retardant epoxy resin; (iv) 35-65 weight percent of a cycloaliphatic anhydride hardener; (v) 0.1-5 weight percent of an encapsulated imidazole catalyst; and (vi) 0-5 weight percent of a fumed silica rheological additive;
(b) heating the composition to 40-80° C.;
(c) dip coating a hairpin portion of the stator in the heated composition;
(d) cooling to allow the coating to set at room temperature;
(e) heating the composition to 60-80° C.;
(f) applying the heated composition to a crown wire portion of the stator via trickling; and
(g) curing both coated portions simultaneously at 150° C. for 1 hour.

11. The process according to claim 10, wherein the composition has a viscosity of 30-50 Pa·s during step (c) and 4-12 Pa·s during step (f).

12. The process according to claim 10, further comprising mixing the composition components in the following order:
(a) mixing the epoxy resins at 30-60° C.;
(b) cooling below 25° C.;
(c) adding the anhydride hardener;
(d) adding the fumed silica;
(e) mixing at 25° C.; and
(f) adding the encapsulated catalyst.

13. The process according to claim 10, wherein step (g) comprises:
(a) heating at 100° C. for 1 hour;
(b) heating at 150° C. for 1 hour; and
(c) heating at 180° C. for 3 hours.

14. An insulated electric vehicle motor stator, comprising:
(a) a stator core having a hairpin portion and a crown wire portion; and
(b) an insulating coating formed from a cured one-component epoxy varnish composition comprising: (i) 20-30 weight percent of at least one bisphenol A based epoxy resin; (ii) 5-10 weight percent of at least one multifunctional epoxy resin; (iii) 5-10 weight percent of a non-halogenated phosphorus-containing flame retardant epoxy resin; (iv) 35-65 weight percent of a cycloaliphatic anhydride hardener; (v) 0.1-5 weight percent of an encapsulated imidazole catalyst; and (vi) 0-5 weight percent of a fumed silica rheological additive; and (c) wherein the coating exhibits a glass transition temperature above 150° C.

15. The insulated stator according to claim 14, wherein the coating has a uniform thickness on both the hairpin portion and crown wire portion.

16. The insulated stator according to claim 14, wherein the coating passes UL94 V-O flammability requirements.

17. The insulated stator according to claim 14, wherein the coating exhibits a hardness of at least 70 Shore D.

18. The insulated stator according to claim 14, wherein the coating has a thermal conductivity between 0.2-2.0 W/m·K.

19. The insulated stator according to claim 14, wherein the coating exhibits moisture absorption of less than 0.6% after 24 hours at 50° C.

20. The insulated stator according to claim 14, wherein the coating maintains at least 80% of its room temperature lap shear strength when tested at 150° C.
